(19) United States
(12) Patent Application Publication
(10) Pub. No.: US 2020/0120053 A1
(43) Pub. Date: Apr. 16, 2020

(54) METHODS FOR CONVEYING INFORMATION THROUGH VISUAL COMMUNICATIONS BY AUTOMATICALLY AND/OR AUTONOMOUSLY GENERATING, CREATING AND/OR USING ONE OR MORE VISUAL COMMUNICATION UNIT(S) FOR VISUAL PORTRAY OF INFORMATION

(71) Applicant: Farimehr Schlake, Great Falls, VA (US)

(72) Inventor: Farimehr Schlake, Great Falls, VA (US)

(21) Appl. No.: 16/159,257

(22) Filed: Oct. 12, 2018

(51) Int. Cl. H04L 12/58; G06F 17/28; G06F 17/30

(52) U.S. Cl. CPC H04L 51/10; G06F 17/30256; G06F 17/2863; G06F 17/289

(57) ABSTRACT

The method of automatically and/or autonomously generating, creating or using one or more visual communication unit(s) to visually portray and convey information to be communicated, visually. This is done automatically, and/or autonomously, and/or driven by, using and/or through algorithms, scientific theories, concepts, methods and modalities, software and/or hardware and/or machine, or a combination of, by automatically, and/or autonomously generating, creating or using one or more visual element(s), picture(s), geometric object(s), painting(s), drawing(s), video(s), movie(s), clip(s), art(s), animation(s), (please note, these are not an exhaustive list of elements), or re-using already made or existing visual communication unit(s), or a combination of, for visually portraying and conveying the information, visually. Then, communicating the visual communication unit(s) through the communication channel(s), tool(s), format(s), and medium(s) of choice. This visual communication can be in lieu of or in conjunction with other written and/or spoken language, voice/audible media, and/or any other communication methods.

### TECHNICAL FIELD

Certain embodiments of the present disclosure generally relate to communications, visual communications, digital communication, telecommunications, instant messaging, messaging, computer and scientific, and Information Technology.

### BACKGROUND

To convey information in communications today, primarily written and/or spoken language in form of voice or written words and sentences utilizing alphabet and numbers are used. Globally, there is a language barrier for communication. Different countries have different languages and to communicate with their people, devices, and applications, in written and/or spoken language, both parties need to know that particular language or agree upon another mutually known language.

In addition, digital and Instant Messaging (IM), texting, and emails follow the same pattern. Typing long sentences and paragraphs is time consuming. Reading those long messages even more cumbersome. Especially in real time and at fast pace. Moreover, much of the daily communication needs are repetitive and re-occurring.

Our increasing mobile phone usage adds up to this discomfort and the need of fast typing. Using the small keys on the phone adds to this unease. The mobile phone use also has introduced a new hazard of texting, while operating attention needing devices, such as texting while driving.

Time has become a commodity in our daily lives. The speed and timing of the communication is increasingly of importance. In many situations, this can be cut short, since just one quick status update suffices, if we had a right communication tool, which could take care of this communication automatically and/or autonomously.

Both speed and ease of communication are of paramount importance in emergency situations, where there is no time for typing.

Furthermore, people with special needs, developmentally disabled or people with acquired disabilities and regenerative and/or brain damaging diseases generally convey their information better and easier through visual communications and for some, this is the only viable way of communications.

Rapid advances in science and technology pave the way and put tremendous demands on convenience, speed, autonomy and automatic communications. The use of algorithms, scientific theories, concepts, methods and modalities, software and/or hardware and/or machine, or a combination of, to automatically and/or autonomously generate, create, use or re-use the visual communication unit(s) is imperative. This will contribute to the speed and ease of communication. It may further result to enhanced transfer of information visually.

### SUMMARY OF DISCLOSURE

Certain embodiments of this disclosure provide a method generally including automatically and/or autonomously generating, creating or using one or more visual communication unit(s) to visually portray and convey information to be communicated, visually. Generally automatically, and/or autonomously, and/or driven by, using, and/or through algorithms, scientific theories, concepts, methods and modalities, software and/or hardware and/or machine, or a combination of, by generally automatically, and/or autonomously generating, creating or using one or more visual element(s), picture(s), geometric object(s), painting(s), drawing(s), video(s), movie(s), clip(s), art(s), animation(s), (please note, these are not an exhaustive list of elements), or re-using already made or existing visual communication unit(s), or a combination of, for visually portraying and conveying the information, visually. Then, generally communicating the visual communication unit(s) through the communication channel(s), tool(s), format(s), and medium(s) of choice.

Certain embodiments of this disclosure provide a method explained above generally in conjunction with or in lieu of written and/or spoken language, sign language, Braille language, bar code, or any machine language, any scripting language, alphabets, numbers, symbols, words, sentences, voice, sound, music, any audibles or any combination of, in the information to be conveyed and/or the visual communication units.

Certain embodiments of this disclosure provide a method explained above generally including a frame around the visual communication unit(s), if chosen to do so.

Certain embodiments of this disclosure provide a method explained above generally including any visual and image format(s), such as jpeg, png, tiff, gif, and/or else (these are not an exhaustive list of available formats).

Certain embodiments of this disclosure provide a method explained above generally including any animation, movie or video format(s), such as gif, apng, webp, mng, flif, and/or else (these are not an exhaustive list of available formats).

Certain embodiments of this disclosure provide a method explained above generally including communicating through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

Certain embodiments of this disclosure provide a method generally including automatically, and/or autonomously generating, creating, or using one or more visual communication unit(s) to visually portray and convey information to be communicated, visually. Generally automatically, and/or autonomously, and/or driven by, using, and/or through algorithms, scientific theories, concepts, methods and modalities, software and/or hardware and/or machine, or a combination of, by automatically, and/or autonomously generating, re-using, or using one or more visual element(s), picture(s), geometric object(s), painting(s), drawing(s), video(s), movie(s), clip(s), art(s), animation(s), (please note, these are not an exhaustive list of elements), or generally re-using or modifying already made or existing visual communication unit(s), or a combination of, for visually portraying and conveying the information, visually. Then, generally communicating the visual communication unit(s) through the communication channel(s), tool(s), format(s), and medium(s) of choice.

Certain embodiments of this disclosure provide a method, explained above in paragraph [0015], generally in conjunction with or in lieu of written, and/or spoken language, sign language, Braille language, bar code, or any machine language, any scripting language, alphabets, numbers, symbols, words, sentences, voice, sound, music, any audibles or any combination of, in the information to be conveyed and/or the visual communication units.

Certain embodiments of this disclosure provide a method, explained above in paragraph [0016], generally including a frame around the visual communication unit(s), if chosen to do so.

Certain embodiments of this disclosure provide a method, explained above in paragraph [0017], generally including any visual and image format, such as jpeg, png, tiff, gif, and/or else (these are not an exhaustive list of available formats).

Certain embodiments of this disclosure provide a method, explained above in paragraph [0017], generally including any animation, movie or video format, such as gif, apng, webp, mng, flif, and/or else (these are not an exhaustive list of available formats).

Certain embodiments of this disclosure provide a method, explained above in paragraph [0017], generally including communicating through the communication channel(s), tool(s), format(s), and medium/media of choice, such as email, instant messaging, texting, facetime, mobile, cellular, satellite, landline, cable, phone, computers, networks, any other form of communications, Artificial Intelligence(AI) and cyber tools, optical communications, or else (these are not an exhaustive list of available communication channels, tools and media).

Certain embodiments of this disclosure provide a method generally including eliminating the need for typing of words and sentences, and the use of written, and/or spoken language. These introduce ease of communication. These visual communication units generally may be re-used as needed in the same re-occurring situations, fast and easily, conveying the same information.

Certain embodiments of this disclosure provide a method generally including providing the means for rapid communications, hence saving time.

Certain embodiments of this disclosure provide a method generally including providing the means for rapid communications, hence saving lives in emergency situations.

Certain embodiments of this disclosure provide a method generally including providing the means for rapid communications, hence saving lives in situations, where attention needing handling of machinery is needed, such as in case of texting while driving.

Certain embodiments of this disclosure provide a method generally including providing the means for visual communications, for people with special needs, developmentally disabled or people with acquired disabilities and regenerative and/or brain damaging diseases, who generally convey their information better and easier through visual communications, and for whom, this visual communication is the only viable way of communications.

Certain embodiments of this disclosure provide a method generally including the use of algorithms, scientific theories, concepts, methods and modalities, software and/or hardware and/or machine, or a combination of, to generally automatically and/or autonomously generate, create, use or re-use the visual communication unit(s). This will help to save time. It may further result to enhanced transfer of information visually.

Certain embodiments of this disclosure provide a method generally including the use of the visual communication unit(s) for communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures and applications).

Certain embodiments of this disclosure provide a method generally including the use of algorithms, scientific theories, concepts, methods and modalities, software and/or hardware and/or machine, or a combination of, to generally automatically and/or autonomously generate, create, use or re-use the visual communication unit(s) by the above in paragraph [0027] mentioned tools, structures, and applications for communications within and/or between and/or among above in paragraph [0027] mentioned tools, structures and applications.

### BRIEF DESCRIPTION OF THE DRAWINGS

A more particular description of the disclosure, briefly summarized above, can be had by reference to the embodiments of this disclosure, some of which are illustrated as examples of drawings, so that the recited features of the present disclosure can be understood in more detail. Please note, however, that the appended drawings are only examples and illustrate typical embodiments of this disclosure and therefore in no way limiting of its scope and diversity of ways to create and illustrate these embodiments. The disclosure may admit to other equally effective embodiments.

FIG. 1 illustrates an example of the proposed automatic and/or autonomous conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “I need Help! Please call Emergency/Medics.”

FIG. 2 illustrates an example of the proposed automatic and/or autonomous conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “On the Way Home!”

FIG. 3 illustrates an example of the proposed automatic and/or autonomous conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “There is a Robbery! Call the Police!”

FIG. 4 illustrates an example of the proposed automatic and/or autonomous conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “I am at the Hospital!”

FIG. 5 illustrates an example of the proposed automatic and/or autonomous conveying of information through visual communication in lieu of written and/or spoken language, writing or typing or method of conveying through voice, in accordance with certain embodiments of the present disclosure. The visual elements in this visual communication unit are created and/or used to sufficiently visually portray and convey the following information: “Staying after school for band/music!”

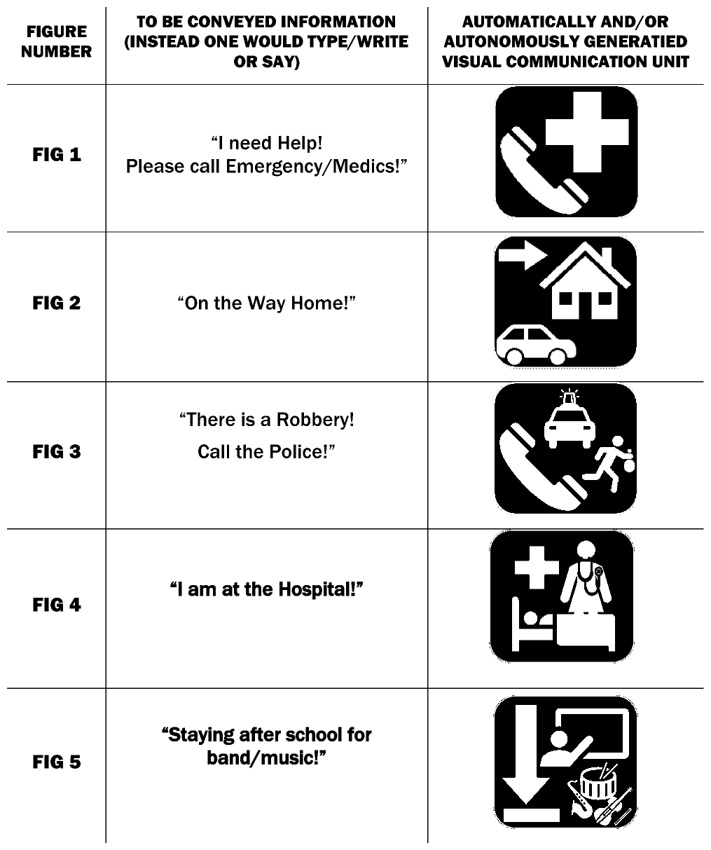

### DETAILED DESCRIPTION AND USE CASES

### DETAILED DESCRIPTION

Embodiments of the present disclosure may automatically, and/or autonomously generate/create one or more visual communication unit(s) to visually portray and convey information visually. This may be done automatically, and/or autonomously, and/or driven by, using, and/or through algorithms, scientific theories, concepts, methods and modalities, software, and/or hardware, and/or machine, or a combination of, by automatically, and/or autonomously generating, creating or using one or more visual element(s), picture (s), geometric object(s), painting(s), drawing(s), video(s), movie(s), clip(s), art(s), animation(s), (please note, these are not an exhaustive list of elements), or re-using already made or existing visual communication unit(s), or a combination of, for visually portraying and conveying the information to be communicated visually. Then, these visual communication unit(s) may be communicated, conveying the information visually, through the communication channel(s), tool(s), format(s), and medium/media of choice.

Embodiments of the present disclosure may be visually portraying and conveying information, visually, by automatically and/or autonomously generating, using/re-using visual communication unit(s). This is may be done automatically, and/or autonomously, and/or driven by, using, and/or through algorithms, scientific theories, concepts, methods and modalities, software, and/or hardware, and/or machine, or a combination of, by automatically, and/or autonomously generating, using/re-using one or more visual element(s), picture (s), geometric object(s), painting(s), drawing(s), video(s), movie(s), clip(s), art(s), animation(s), (these are not an exhaustive list of elements), or re-using already made or modifying existing visual communication unit(s), or a combination of, for visually portraying and conveying the information to be communicated visually. Then, these visual communication unit(s) may be communicated, conveying the information visually, through the communication channel(s), tool(s), format(s), and medium/media of choice.

In certain embodiments of the present disclosure, the visual communication unit(s), and/or the information to be conveyed may be in lieu of or in conjunction with spoken, and/or written language, sign language, Braille language, bar code, or any machine language, any scripting language, alphabets, numbers, symbols, words, sentences, voice, sound, music, any audibles or any combination of.

Embodiments of the present disclosure may include a frame around the visual communication unit(s), if chosen to do so.

Embodiments of the present disclosure may be in any visual and image format, such as jpeg, png, tiff, gif, and/or else (these are not an exhaustive list of available formats).

Embodiments of the present disclosure may be in any animation, movie or video format, such as gif, apng, webp, mng, flif, and/or else (these are not an exhaustive list of available formats).

Embodiments of the present disclosure may be communicated through the communication channel(s), tool(s), format(s), and medium/media of choice, such as email, instant messaging, texting, facetime, mobile, cellular, satellite, landline, cable, phone, computers, networks, any form of communications, Artificial Intelligence(AI) and cyber tools, optical communications, or else (these are not an exhaustive list of available communication channels, tools and media).

Embodiments of the present disclosure may use the visual communication unit(s) for communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

Embodiments of the present disclosure may create, use or re-use the visual communication unit(s) by the above in paragraph [0042] mentioned tools, structures, and applications for communications within, and/or between, and/or among above in paragraph [0042] mentioned tools, structures and applications.

### Use Cases

Embodiments of the present disclosure may allow fast communication to take place. The proposed visual communication may eliminate the need for any type of written and/or spoken language, typing, and/or writing, words and sentences, however, they may be included, if chosen to do so. Having to type words and sentences as the only way for communication may introduce danger in many use cases, where attention in operating devices and applications may be required, such as in case of texting while driving.

Embodiments of the present disclosure may allow fast visual communication to take place. Visual communication units may be generated/created automatically, and/or autonomously and/or driven by, using, and/or through algorithms, scientific theories, concepts, methods and modalities, software, and/or hardware, and/or machine, or a combination of, to convey spoken language and voice communication, sound, music, any audibles or any combination of, visually. This may introduce ease of communication and may provide diversity of communication choice and methods, based on usage scenario and user preference and need.

Furthermore, daily communication and status update may consist of many repetitive sentences, that may be conveyed through one visual unit. Some communication may need more of these units to be used, depending on the particular embodiments of the present disclosure created and used. This/These unit(s) may be re-used as needed in the same re-occurring situations, fast and easily, conveying the same information.

Embodiments of the present disclosure may be used in emergency, alert systems, Personal Emergency Response Systems (PERS), and disaster recovery situations, where rapid and selective choice of communication may be of utmost importance and typing and texting is cumbersome and many times impossible.

Embodiments of the present disclosure may be also used in applications and device communications with Application-to-People (A2P), People-to-Application (P2A), Application-to-Application (A2A), and/or device to device, and/or system-to-system, and/or organic structure-to-structure, and/or in-organic structure-to-structure, (please note, these are not an exhaustive list of applications and devices). It may be used for any status updates and customer relationship management, event planning and reminder communications. This fast and easy visual communication may benefit consumers and enterprises the same. Healthcare, doctors, educational, law enforcement, work force, field force, sales and marketing, transportation, logistics, finance, and global governments may benefit from this rapid method of visual communication.

Embodiments of the present disclosure may be also used in tools, structures, applications and device communications within, and/or between, and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

Embodiments of the present disclosure may eliminate the language barrier in international and global communications. Visual communication may mostly convey the same information and be interpreted easily without language barrier across the globe. People of different regions, countries, cultures, spoken languages and dialects may communicate with each other effortlessly using this visual communication.

The embodiments of the present disclosure may provide the means for blind people to be able to visually communicate.

Please note, the above use cases are only examples of many and in no means limiting the scope of implementation of the embodiments of the present disclosure.

1. A method for automatically and/or autonomously generating/creating one or more visual communication unit(s) to visually portray and convey information visually comprising:
a. Autonomously and/or automatically and/or driven by using and/or through algorithms, scientific theories, concepts, methods and modalities, software and/or hardware and/or machine, or a combination of, generating, creating or using one or more visual element(s), picture(s), geometric object(s), painting(s), drawing(s), video(s), movie(s), clip(s), art(s), animation(s), or re-using already made or existing visual communication unit(s), or a combination of, for visually portraying and conveying the information to be communicated visually.
b. Communicating the visual communication unit(s) conveying the information visually through the communication channel(s), tool(s), format(s), and medium/media of choice.

2. The method of claim 1 wherein the step (a.) is done in conjunction with or in lieu of spoken and/or written language, sign language, Braille language, bar code, or any machine language, any scripting language, alphabets, numbers, symbols, words, sentences, voice, sound, music, any audibles, or any combination of, in the information to be conveyed and/or the visual communication units.

3. The method of claim 2 further comprising a frame around the visual communication unit if chosen to do so.

4. The method of claim 3 wherein the visual communication unit(s) is/are in any visual and image format, such as jpeg, png, tiff, gif, and/or else (these are not an exhaustive list of available formats).

5. The method of claim 3 wherein the visual communication unit(s) comprise(s) any animation, movie or video format, such as gif, apng, webp, mng, flif, and/or else (these are not an exhaustive list of available formats).

6. The method of claim 4 wherein the communicating step (b.) of method 1 is done through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

7. The method of claim 5 wherein the communicating step (b.) of method 1 is done through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

8. A method of automatically and/or autonomously visually portraying and conveying information visually, using/re-using visual communication unit(s) comprising:
a. Autonomously and/or automatically and/or driven by using and/or through algorithms, scientific theories, concepts, methods and modalities, software and/or hardware and/or machine, or a combination of, re-using or using one or more visual element(s), picture(s), geometric object(s), painting(s), drawing(s), video(s), movie(s), clip(s), art(s), animation(s), or re-using or modifying already made or existing visual communication unit(s), or a combination of, for visually portraying and conveying the information to be communicated visually.
b. Communicating the visual communication unit(s) conveying the information visually through the communication channel(s), tool(s), format(s), and medium/media of choice.

9. The method of claim 8 wherein the step (a.) is done in conjunction with or in lieu of spoken and/or written language, sign language, Braille language, bar code, or any machine language, any scripting language, alphabets, numbers, symbols, words, sentences, voice, sound, music, any audibles or any combination of, in the information to be conveyed and/or the visual communication units.

10. The method of claim 9 further comprising a frame around the visual communication unit(s) if chosen to do so.

11. The method of claim 10 wherein the visual communication unit(s) is/are in any visual and image format(s), such as jpeg, png, tiff, gif, and/or else (these are not an exhaustive list of available formats).

12. The method of claim 10 wherein visual communication unit(s) comprise(s) any animation, movie or video format(s), such as gif, apng, webp, mng, flif, and/or else (these are not an exhaustive list of available formats).

13. The method of claim 11 wherein the communicating step (b.) of method 8 is done through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

14. The method of claim 12 wherein the communicating step (b.) of method 8 is done through the communication channel(s), tool(s), format(s), and medium/media of choice, such as email, instant messaging, texting, facetime, mobile, cellular, satellite, landline, cable, phone, computers, networks, any form of communications, Artificial Intelligence and cyber tools, optical communications, or else (these are not an exhaustive list of available communication channels, tools and media).

15. The method of claim 3 wherein the automatically and/or autonomously created, generated, used/re-used visual communication unit(s) is/are used for communications within and/or between and/or among computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures (please note, this list is not an exhaustive list of possible tools, structures, and applications).

16. The method of claim 3 wherein the visual communication unit(s) is/are automatically and/or autonomously created, generated, used/re-used by use of algorithms, scientific theories, concepts, methods and modalities, software and/or hardware and/or machine, or a combination of, by computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures (please note, this list is not an exhaustive list of possible tools, structures, and applications), for communications within and/or between and/or among these tools, structures, and applications.

17. The method of claim 10 wherein the automatically and/or autonomously created, generated, used/re-used visual communication unit(s) is/are used for communications within and/or between and/or among human bodies, organic structures, inorganic structures, computers, phones, any form of communication device, gadgets, wearable technologies, watches, glasses, sensors, actuators, processors, microprocessors, toys, vehicles, any devices and hardware, any software, appliances, any structures, tools, buildings, monitors, keyboards, mice, any parts of a system (please note, this list is not an exhaustive list of possible tools, structures, and applications).

18. The method of claim 10 wherein the visual communication unit(s) is/are automatically and/or autonomously created, generated, used/re-used by use of algorithms, scientific theories, concepts, methods and modalities, software and/or hardware and/or machine, or a combination of, by computers, phones, any form of communication device, gadgets, wearable technologies, organic structures, inorganic structures, watches, glasses, sensors, actuators, processors, microprocessors, toys, vehicles, any devices and hardware, any software, appliances, any structures, tools, buildings, monitors, keyboards, mice, any parts of a system, human bodies, organic structures, inorganic structures (please note, this list is not an exhaustive list of possible tools, structures, and applications), for communications within and/or between and/or among these tools, structures, and applications.
